(19) United States
(12) Patent Application Publication
(10) Pub. No.: US 2008/0285027 A1
(43) Pub. Date: Nov. 20, 2008

(54) Hyperspectral / Multispectral Dispersive System with Scanning Entry Slit Moving Across Lens Focus Plane

(75) Inventor: Mark Allen Lanoue, Long Beach, MS (US)

Correspondence Address: Emerging Technologies, LLC, 122 Carroll Avenue, Long Beach, CA, 39560, US

(73) Assignee: Emerging Technologies, LLC (A Mississippi Company)

(21) Appl. No.: 12/104,631

(22) Filed: Apr. 17, 2008

Related U.S. Application Data
(60) Provisional application No. 60/938,633, filed on May 17, 2007.

(51) Int. Cl. G01J 3/40

(52) U.S. Cl. 356/302

(57) ABSTRACT

Most scanning systems today employ the conventional prior art method of using mirrors, moving the lens, rotating the slit, and moving the internal optics of the system. This system moves the slit plane across the projected focal plane that is formed by the fore/objective lens.

The basic system includes a camera/sensor, a dispersive spectrograph with entrance slit, a computer with control software, an encoded stage and/or motor control, an objective lens, a computer, and an enclosure.

The system works as a stationary enclosure with internal moving parts. The spectrograph and camera are moved in precision by a linear stage in the vertical or horizontal plane depending on whether the slit is vertically set or horizontally set. The precision movement of the assembly is controlled via an intelligent motor controller interface and customized software.

### BACKGROUND OF THE INVENTION

In this invention the slit plane is used to scan the plane of focus projected by the lens mounted in front of the slit plane.

The end-user via a custom designed user interface endowed by a code engine that runs the higher order functions behind the scenes can choose the area and size of his or her dataset based on the variables, optical and hardware limitations, and functionality of the complete system. This interface software will then engage the system to scan the focus plane within the boundaries of focus that is free of distortions and boundary anomalies.

At the end of the scan, the end-user will have a three dimensional dataset based on spatial and spectral characteristics of a given target within the parameters set forth by the end-user, within the boundaries of the system and software.

For example: the end-user places a target in front of the scanning system lens at some given distance, the end-user then engages the custom software preview via the GUI interface, the end-user then focuses to the target by adjusting the focus on the objective lens. The software is then engaged based on the user settings within the boundaries set forth by system limitations. The custom software engages the system by precisely scanning the focus plane projected by the target, while using geometric correction functions to keep the target geometrically correct. The system automatically scans the focus plane within a given range in order to avoid outer focus plane distortions and anomalies projected on the outer limits of the focus plane. Each scan line acquisition is saved into a three dimensional array data set on the hard drive, via the custom software. This is achieved by the computer controlled encoder and stage that moves the slit precisely across the focus plane from the objective lens, while acquiring an image in the spatial (X Dimension, and Y Dimension) and the spectral data in the (Z dimension) for each precision scan line. It is thereby a more desirable method for scanning the target, due to the gain in throughput compared to conventional mirrors, the constant position of Nadir for the objective lens, there is no movement of parts except within the optical motor assembly, and the robustness and sturdiness of the scanning mechanism.

Hyperspectral imaging systems in general are known, and have been used for a plethora of remote sensing and analytical techniques, such as is disclosed, for example, in U.S. Pat. No. 5,790,188, related U.S. Pat. No. 6,998,614, and related U.S. Pat. No. 6,211,906. Hyperspectral imaging has also been used in conjunction with microscopic optical systems, such as disclosed, for example, in U.S. Pat. No. 6,495,818. In these systems, radiation reflected and refracted by or emanating from a target or specimen is detected in a large number of narrow yet contiguous spectral bands, producing a three dimensional data set which is distributed with high spatial images that also have high spectral data in the third dimension of the data set. For each pixel within the image of the target, information is recorded in each of the spectral bands, thereby producing a three-dimensional hyperspectral image cube. The current systems being used deal with scanning the actual target area and photons using conventional means where the lens accepts the target and the scanning mechanism scans that target within the degree of freedom of the lens. In other applications a mirror is used to scan the target in front of a lens that is placed in front of a slit. One of the latest designs is that of a lens moving up and down across the target and slit plane so that the target can be scanned without moving the camera or target.

### DETAILED DESCRIPTION OF SPECIFIC EMBODIMENTS

Reference will now be made to the detailed embodiment of the invention. This invention pertains to the process of scanning the plane of focus projected by the objective lens by the optical entrance slit affixed in front of the dispersion optics.

A computer controlled translation stage moves the dispersion optics (spectrograph) which is fixed to a camera at the optics dispersion output path and has an entrance slit at the input path, is translated either horizontally or vertically so that the entrance slit traverses across the projected plane of focus within the distance allowing for quality data. This distance is measured and defined by the assembler in order to avoid vignetting and extreme outer distortions.

The utility for this scanning methodology is that it improves the data quality of prior art scanning systems. The mirror-based scanners drop throughput and introduce slight errors to the data flow of photons entering the slit plane. This method allows the photons to flow straight from the lens path to the optical slit while the slit scans across the focus plane projected by the lens. The technology that scans the lens across the slit plane causes the lens to move from NADIR/Center position, which introduces variants associated with light distribution, introduces the possibility of adding stray light caused by the movement of the Focus Plane in the internal chamber of the scanner, and it introduces the possibility of extra optical distortion. This invention has the lens in NADIR/Center position at all times, which avoids these problems.

The method of scanning for this invention differs from conventional push-broom satellite scanners in that the slit and optics in this case are moved to image the plane of focus projected by the objective lens.

The invention will be controlled by a computer or computer board and custom software that threads commands among the camera, the computer and the motor control in order to accurately scan the plane of focus and store a spatial and spectral three dimensional data set onto a storage media.

### BRIEF DESCRIPTION OF DRAWINGS

FIG. 1 is a side view of the system that contains the unique scanning methodology. The cover is not present in this figure.

FIG. 2 is the front view of the system.

FIG. 3 is the side view of the system with the protective housing affixed to the assembly.

Simple Flow:
1. Objective lens stays at fixed position.
2. The lens creates a Plane of Focus of the target in front of the lens and projects that Plane of Focus between the back of the objective lens and in front of the entrance slit.
3. The entrance slit is moved across this Plane of Focus using a precision computer controlled stage via a motor and encoder.
4. Each acquisition line is then saved into a three dimensional data cube with spatial and spectral data on a hard media (hard drive, optical disk, flash, RAM, etc.)

FIG. 4 shows how the data is obtained and processed before storage.

### DETAILED DESCRIPTION OF DRAWINGS

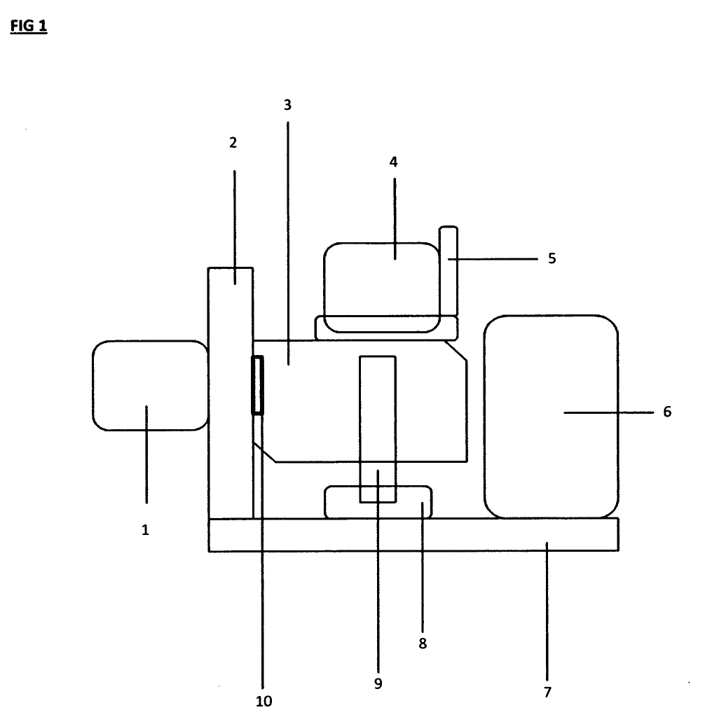

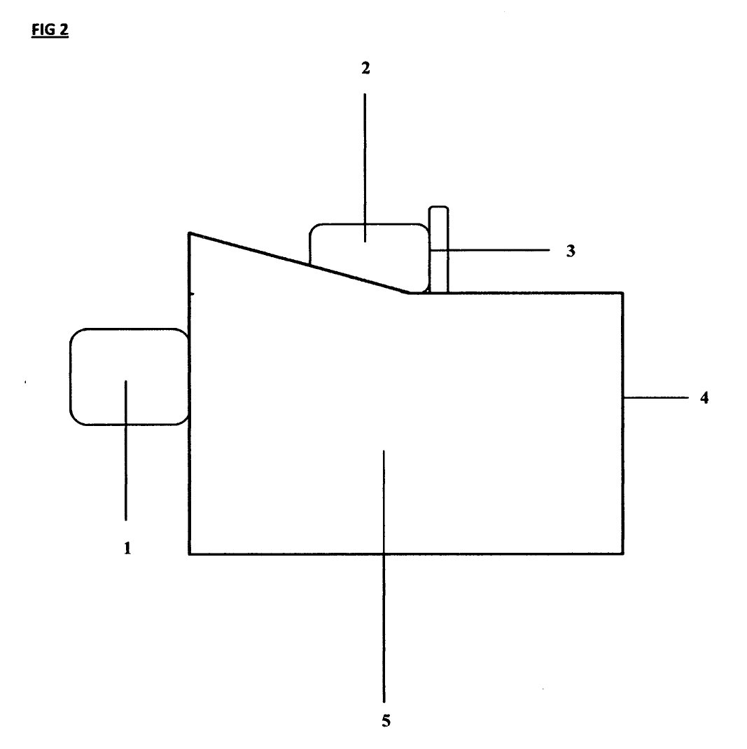

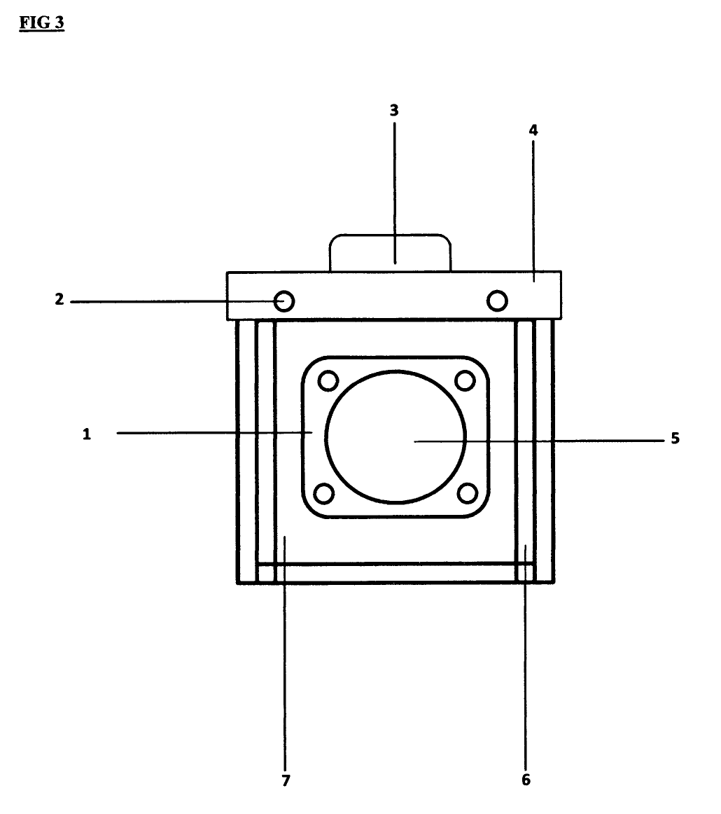

FIGS. 1, 2, and 3 show, respectively, a conceptual block drawing, and a schematic perspective view of the scanning system, its assembly, its housing, and its components according to the invention. As can be seen in FIG. 1 in particular, the entire labeled assembly that enables the scanning of the target per the method of the invention.

FIG. 1 shows the following components that make up the scanning assembly that embodies the computer controlled parts to produce the method that makes up the invention: Lens, stage mount, spectrograph, motor controller, motor/computer controlled stage, camera/sensor, base plate, and housing assembly.

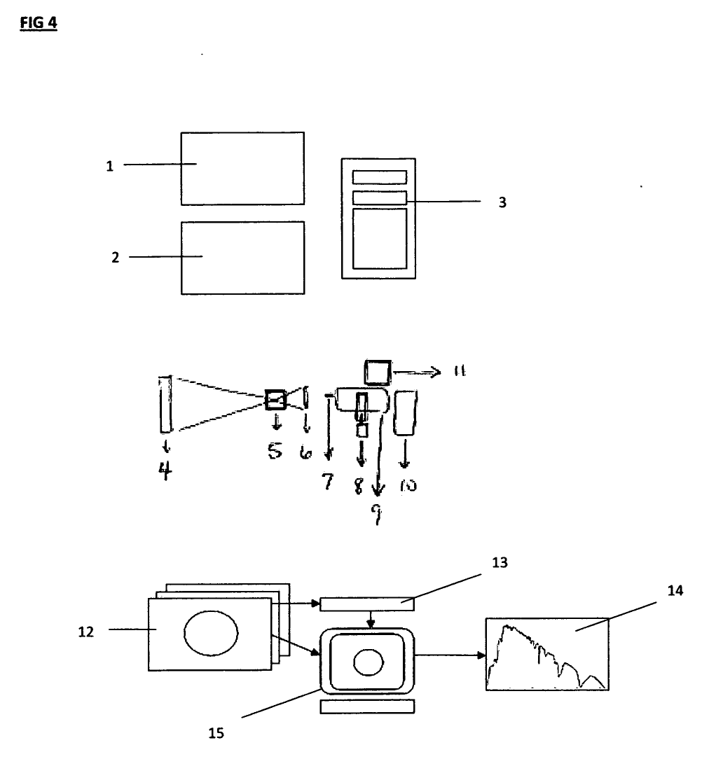

FIG. 4 shows the schematic of the process. This process uses a computer, specialized programming code, computer controlled modules, a user-friendly interface, and specialized software commands. This process is what controls the function of this invention.

What is claimed is:

1. A precision computer controlled motor moving the camera and optics assembly that are affixed to a linear stage that is affixed to the base plate for the entire system assembly with an optical slit at the front end of the dispersion optics so that the optical slit is moved in a controlled precision fashion across the plane of focus between the objective lens and the entrance slit. The motor for the invention is a type that defines the accurate start position, stop position, and scanning position of the slit across the Focus Plane projected by the objective lens. An optional small linear stage that moves the optical assembly forward and backwards to an accurate position for optimal infinity focus with changing focal numbers on objective lenses.

2. The objective lens remains fixed to an assembly mounting framework that houses the moving parts that are made up of the scanning mechanism and optics so that the objective lens has a distance between it and the slit where the Focus plane remains fixed for accuracy in focusing on the target or Infinity focus while scanning. The invention scanning assembly is fixed to the motor, the motor control, and the optics. The scanning Assembly has a protective housing that also has the data ports and power ports fixed to it. The power and data cables are fixed internally within the scanning assembly protective housing; to the data and power ports and to the devices internal to the housing. The sensor/camera is fixed to the moving/scanning optics. The slit is located at the front of the optics assembly/spectrograph, which is located behind the Focus Plane and behind the objective lens.

3. The invention has an optional intelligence component that can be added to the features of the system, which include flash memory, internal storage medium/media, a board computer within the scanning assembly case, a wireless feature, internal memory within the scanning assembly case, and stage cooling within the assembly case. This will all be referred to as the intelligent system package. This Intelligent package/invention will be driven and controlled by custom software with a user-interface that incorporates motor functionality, data acquisition, algorithm functionality for the system, wireless control systems, data storage functions, calibration and testing functions, preview, scanning, image display functions, spectral and spatial routines and functions, data base and project-based functions, camera control functions, error logging, batch processing, and noise removal routines.
